(19) United States
(12) Patent Application Publication
(10) Pub. No.: US 2023/0415572 A1
(43) Pub. Date: Dec. 28, 2023

(54) VEHICLE DISPLAY DEVICE

(71) Applicant: YAZAKI CORPORATION, Tokyo (JP)

(72) Inventors: Yoshihisa Yamada, Makinohara-shi (JP); Takayuki Ogawa, Makinohara-shi (JP)

(21) Appl. No.: 18/330,375

(22) Filed: Jun. 7, 2023

(30) Foreign Application Priority Data
Jun. 23, 2022 (JP) 2022-100786

(51) Int. Cl. B60K 35/00; G02B 27/14

(52) U.S. Cl. CPC B60K 35/00; G02B 27/144; B60K 2370/23; B60K 2370/693

(57) ABSTRACT

A vehicle display device includes an image display device including an upper display area and a lower display area, a hood part, a combiner disposed on a side of the eye point with respect to the upper display area, an accommodating part that has an opening facing upward, a transparent cover, a panel member having a through hole facing the cover, a reflective member disposed inside the accommodating part, and a mask part disposed on the cover. The through hole has a shape with a widened portion expanding outward from an area through which the display light traveling toward the eye point passes, and the mask part is provided in an area of the cover facing the widened portion.

### CROSS-REFERENCE TO RELATED APPLICATION(S)

The present application claims priority to and incorporates by reference the entire contents of Japanese Patent Application No. 2022-100786 filed in Japan on Jun. 23, 2022.

### BACKGROUND OF THE INVENTION

### 1. Field of the Invention

The present invention relates to a vehicle display device.

### 2. Description of the Related Art

The related art discloses vehicle display devices with combiners. Japanese Patent No. 5961372 discloses a vehicle display device including a display device body that emits display light and a combiner fixed to an upper part of the display device body and projected with the display light emitted from the display device body. In the vehicle display device of Japanese Patent No. 5961372, the display light is emitted outside a housing through a front glass of an opening of the housing and irradiated a display area of the combiner.

When the display light is projected toward the combiner from the display device through an opening formed in a wall surface, the combiner may reflect not only an image display area of the display device but also an opening surrounding the image display area. It is desirable to be able to suppress deterioration in designability due to the reflection of the opening in the combiner.

### SUMMARY OF THE INVENTION

An object of the present invention is to provide a vehicle display device that can improve designability.

In order to achieve the above mentioned object, a vehicle display device according to one aspect of the present invention includes an image display device including an upper display area and a lower display area for displaying an image and disposed so that the upper display area faces an eye point of a vehicle; a hood part that covers the upper display area from a front side of the vehicle; a combiner disposed on a side of the eye point with respect to the upper display area; an accommodating part that accommodates the lower display area and has an opening facing upward, the opening being located on a side of the eye point with respect to the image display device; a transparent cover that closes the opening; a panel member disposed on a side of the combiner with respect to the cover and having a through hole facing the cover; a reflective member disposed inside the accommodating part, facing the combiner through the through hole, and reflecting display light of the lower display area toward the combiner; and a mask part having a light-shielding property and disposed on the cover, wherein the through hole has a shape with a widened portion expanding outward from an area through which the display light traveling toward the eye point passes, and the mask part is provided in an area of the cover facing the widened portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross-sectional view of a vehicle display device according to an embodiment;

FIG. 2 is a perspective view of the vehicle display device according to the embodiment;

FIG. 3 is a side view of a panel member according to the embodiment;

FIG. 4 is an enlarged view of the panel member according to the embodiment;

FIG. 5 is a front view of the vehicle display device according to the embodiment;

FIG. 6 is a front view of the vehicle display device according to the embodiment;

FIG. 7 is a plan view of the panel member according to the embodiment;

FIG. 8 is a plan view of the panel member and a cover according to the embodiment;

FIG. 9 is an enlarged view of the cover according to the embodiment;

FIG. 10 is a side view of the cover according to the embodiment;

FIG. 11 is a view illustrating image display by the vehicle display device of the embodiment;

FIG. 12 is a plan view of the panel member according to the embodiment;

FIG. 13 is a plan view of the panel member and the cover according to the embodiment;

FIG. 14 is a view illustrating image display by the vehicle display device of the embodiment;

FIG. 15 is a plan view of a panel member and a cover of a comparative example;

FIG. 16 is a view illustrating image display by a vehicle display device of a comparative example;

FIG. 17 is a view illustrating the results of sensory evaluation;

FIG. 18 is a perspective view of a panel member according to a variation of the embodiment; and

FIG. 19 is a perspective view of a panel member according to a variation of the embodiment.

### DETAILED DESCRIPTION OF THE PREFERRED EMBODIMENTS

A vehicle display device according to an embodiment of the present invention is described in detail below with reference to the drawings. Note that the invention is not limited by this embodiment. Components in the following embodiment include those that can be easily assumed by those skilled in the art or are substantially the same.

### Embodiment

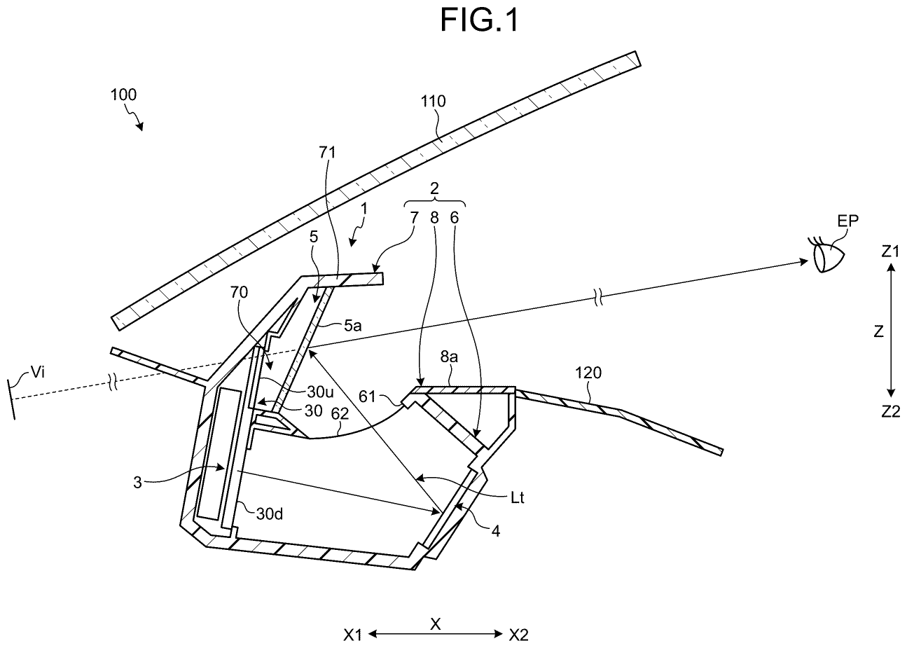

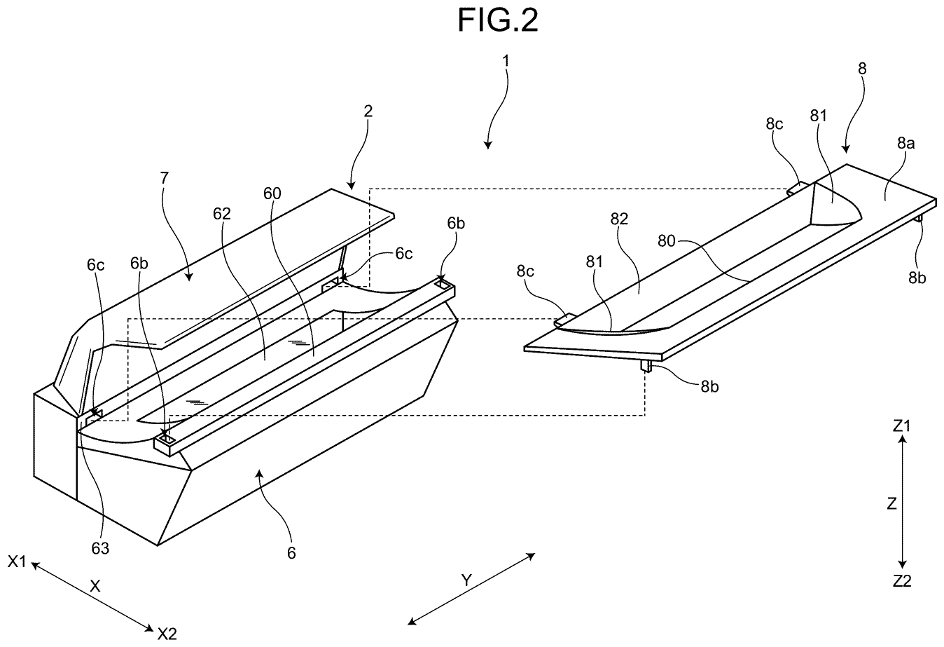

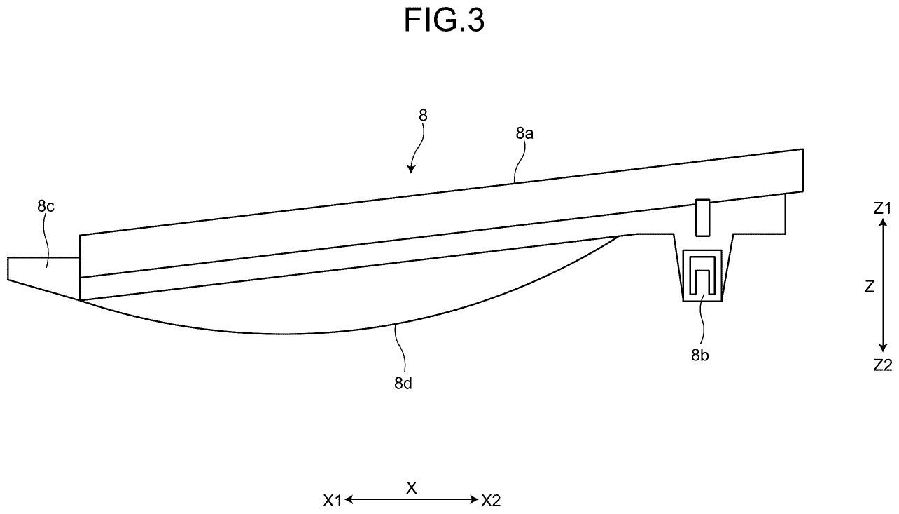

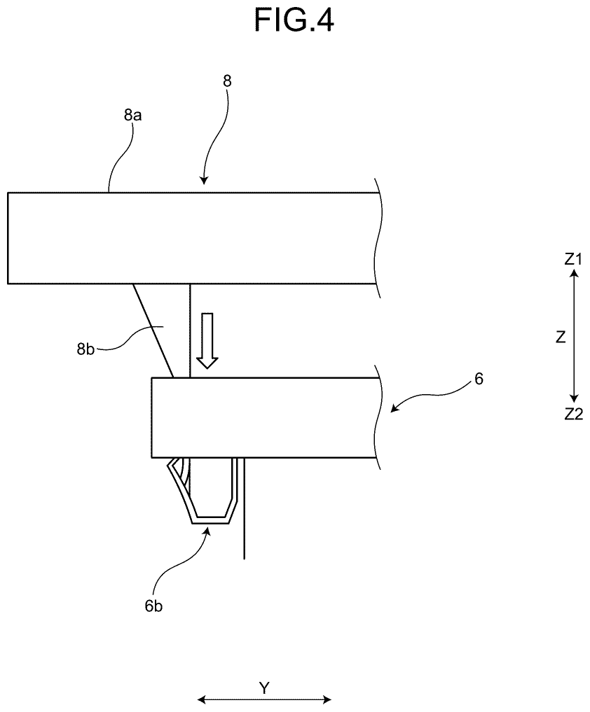

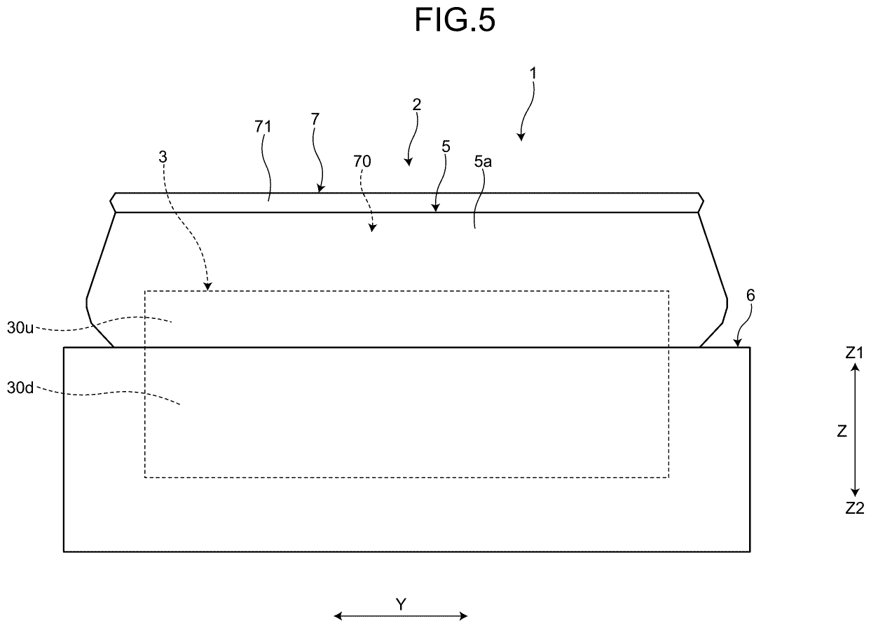

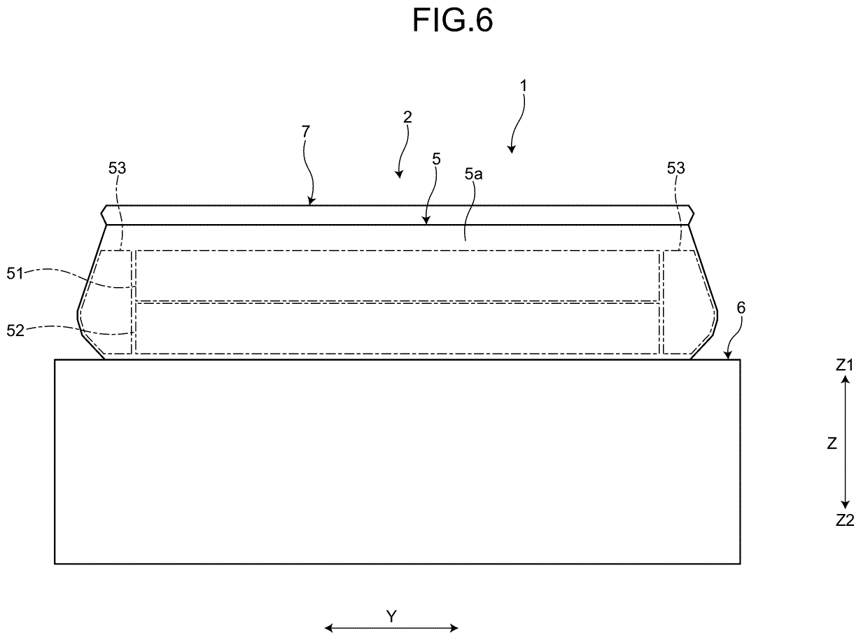

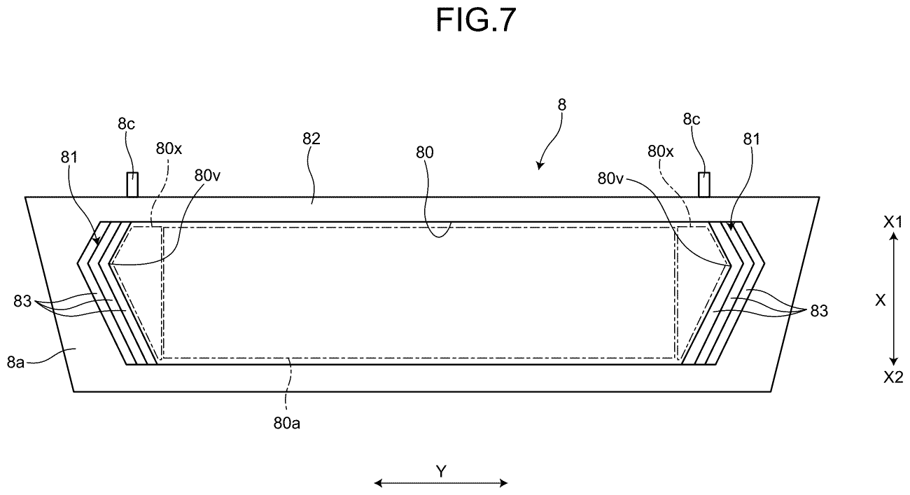

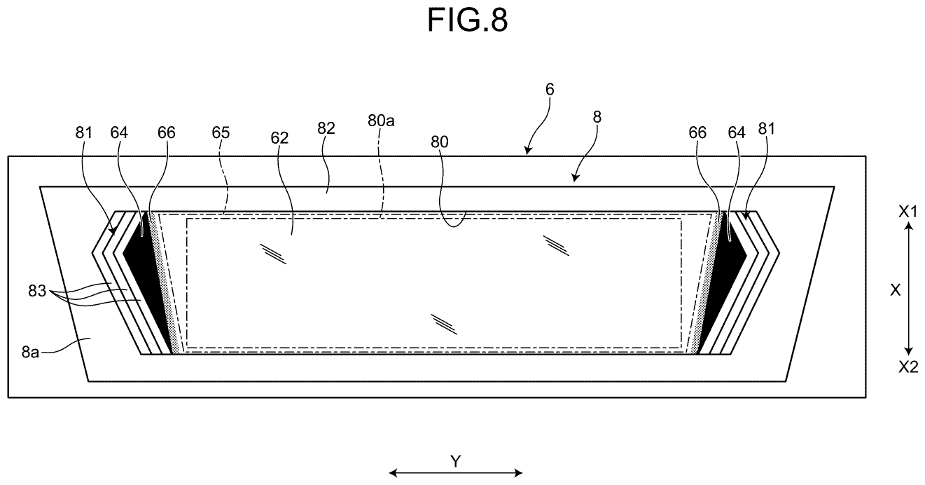

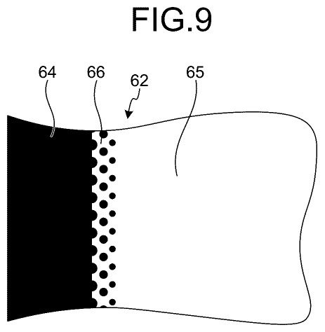

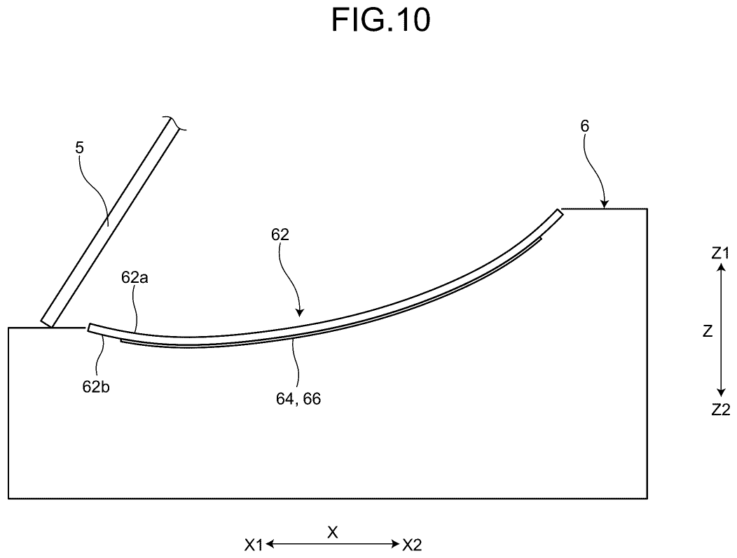

With reference to FIGS. 1 to 17, the embodiment is described. The present embodiment relates to a vehicle display device. FIG. 1 is a cross-sectional view of a vehicle display device according to the embodiment, FIG. 2 is a perspective view of the vehicle display device according to the embodiment, FIG. 3 is a side view of a panel member according to the embodiment, FIG. 4 is an enlarged view of the panel member according to the embodiment, FIGS. 5 and 6 are front views of the vehicle display device according to the embodiment, FIG. 7 is a plan view of the panel member according to the embodiment, FIG. 8 is a plan view of the panel member and a cover according to the embodiment, FIG. 9 is an enlarged view of the cover according to the embodiment, and FIG. 10 is a side view of the cover according to the embodiment.

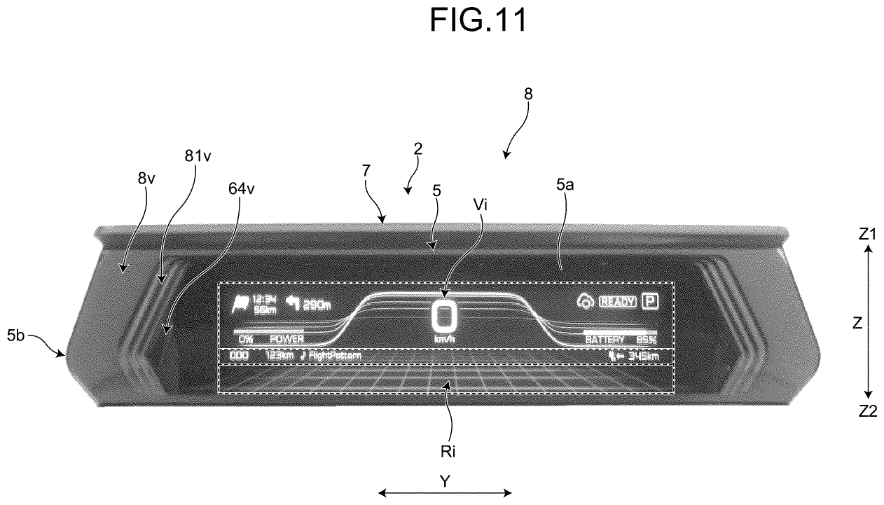

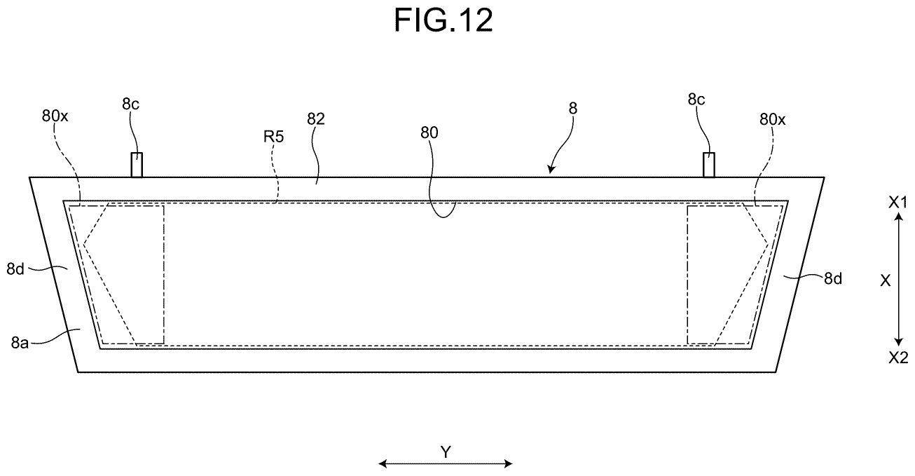

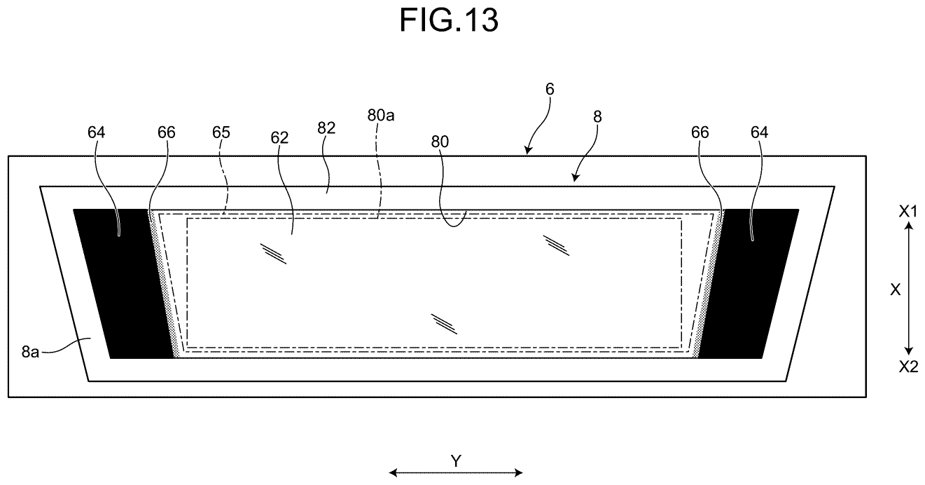

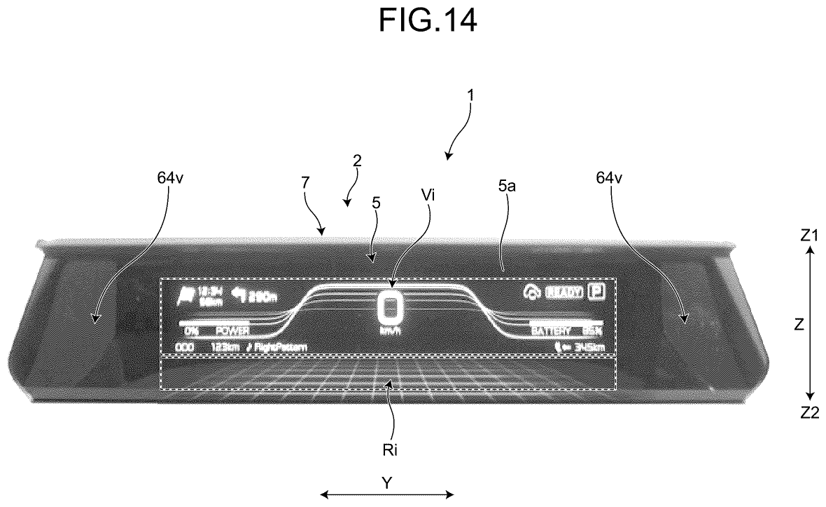

FIG. 11 is a view illustrating image display by the vehicle display device of the embodiment, FIG. 12 is a plan view of the panel member according to the embodiment, FIG. 13 is a plan view of the panel member and the cover according to the embodiment, and FIG. 14 is a view illustrating image display by the vehicle display device of the embodiment.

As illustrated in FIG. 1, a vehicle display device 1 has a housing 2, an image display device 3, a reflective member 4, and a combiner 5. The vehicle display device 1 is mounted on a vehicle 100 such as an automobile. The vehicle display device 1 of the present embodiment is a meter device capable of displaying a virtual image in front of a driver by means of the combiner 5. The illustrated vehicle display device 1 is disposed on an instrument panel 120.

The vehicle display device 1 of the present embodiment is configured to display a real image and a virtual image with respect to an eye point EP of the vehicle 100. More specifically, the vehicle display device 1 allows the driver to visually recognize, as a real image, an image displayed on an upper part of the image display device 3, and to visually recognize, as a virtual image, an image displayed on a lower part of the image display device 3. Note that the eye point EP is a position assumed in advance as a position of an eye of the driver or an actual position of the eye of the driver.

The housing 2 has an accommodating part 6, a hood part 7, and a panel member 8. The accommodating part 6 and the hood part 7 may be integrally formed with each other or separate members. The accommodating part 6 is accommodated in the instrument panel 120. The accommodating part 6 has a box shape and has a light-shielding property. The accommodating part 6 has an opening 61 opened upward. The opening 61 is located at the top of the accommodating part 6. The opening 61 is located on a rear side X2 with respect to the image display device 3, that is, on the side of the eye point EP.

A transparent cover 62 is placed over the opening 61. The cover 62 closes the opening 61. The cover 62 has a curved shape toward the inside of the accommodating part 6. The cover 62 is formed to reflect external light toward a light-shielding wall. For example, the cover 62 reflects external light transmitted through a windshield 110 toward a wall surface of the hood part 7 or a direction other than the eye point.

In the following description, a front side in a vehicle front-rear direction X is referred to as a “front side X1” and a rear side in the vehicle front-rear direction X is referred to as a “rear side X2”. An upper side in a vehicle vertical direction Z is referred to as an “upper side Z1” and a lower side in the vehicle vertical direction Z is referred to as a “lower side Z2”. An image longitudinal direction of an image displayed by the vehicle display device 1 corresponds to the vehicle vertical direction Z.

As illustrated in FIG. 2, the panel member 8 of the present embodiment is detachable from the accommodating part 6. The panel member 8 is disposed on the side of the combiner 5 with respect to the cover 62. The panel member 8 is a light-shielding member, for example, is molded from resin. The panel member 8 has an instrument panel surface 8a, a plurality of clips 8b, and a plurality of protruding portions 8c. The instrument panel surface 8a constitutes a continuous surface with a top surface of the instrument panel 120. The instrument panel surface 8a, for example, has a surface finish similar to the top surface of the instrument panel 120. The clip 8b is an engaging portion disposed at an edge of the rear side X2 in the panel member 8. The clip 8b protrudes toward the lower side Z2. The protruding portion 8c is disposed at a front end of the panel member 8 and protrudes toward the front side X1.

The accommodating part 6 has a plurality of engaging portions 6b for receiving the clips 8b and a plurality of recessed portions 6c for receiving the protruding portions 8c. The engaging portion 6b is disposed on the rear side X2 with respect to the cover 62. More specifically, the accommodating part 6 has a support portion 60 protruding toward the upper side Z1. The support portion 60 supports the panel member 8 from below. The support portion 60 extends from one end to the other end of the accommodating part 6 along a vehicle width direction Y. The position of the support portion 60 in the vehicle front-rear direction X is near the side of the rear side X2 in the cover 62. The engaging portions 6b are disposed at both ends of the support portion 60.

The recessed portion 6c is disposed on the front side X1 with respect to the cover 62. More specifically, the accommodating part 6 has a wall portion 63 located on the lower side Z2 of the hood part 7. The wall portion 63 faces the rear side X2 and extends along the vehicle width direction Y. The recessed portions 6c are disposed at both ends of the wall portion 63.

As illustrated in FIG. 2, the protruding portion 8c of the panel member 8 is inserted into the recessed portion 6c of the accommodating part 6 along the vehicle front-rear direction X. The clip 8b is inserted into the engaging portion 6b along the vehicle vertical direction Z. As illustrated in FIG. 4, the engaging portion 6b has a concave shape into which the clip 8b can be inserted. The engaging portion 6b has a claw or the like for locking the clip 8b. The panel member 8 is fixed to the accommodating part 6 by engaging the clips 8b with the corresponding engaging portions 6b.

The vehicle display device 1 of the present embodiment is configured so that the panel member 8 can be exchanged without removing the instrument panel 120. That is, in a state in which the accommodating part 6 is fixed to the vehicle 100, the panel member 8 can be removed from the accommodating part 6 without interfering with the instrument panel 120, and can be attached to the accommodating part 6 without interfering with the instrument panel 120.

As illustrated in FIG. 2, the panel member 8 has a through hole 80 passing through the panel member 8 in a plate thickness direction. The through hole 80 is disposed at a position facing the cover 62. That is, in a state in which the panel member 8 is fixed to the accommodating part 6, the entire through hole 80 faces the cover 62. The panel member 8 has inclined portions 81 and 82 adjacent to the through hole 80. The inclined portions 81 are disposed on both sides of the through hole 80 in the vehicle width direction Y. The inclined portion 82 is disposed on the front side X1 with respect to the through hole 80. The inclined portions 81 and 82 are inclined toward the lower side Z2 as they approach the through hole 80.

The image display device 3 is a device that displays images, and is, for example, a liquid crystal display device such as a thin film transistor-liquid crystal display (TFT-LCD). The image display device 3 has a backlight unit, and outputs display light using light from the backlight unit. As illustrated in FIG. 1, the image display device 3 has an upper display area 30u and a lower display area 30d. The upper display area 30u and the lower display area 30d are light-emitting areas that output the display light. The upper display area 30u is located on the upper side Z1 in a display surface 30 of the image display device 3. The lower display area 30d is located on the lower side Z2 in the display surface 30.

The image display device 3 is disposed with the upper display area 30u facing the eye point EP. The image display device 3 is fixed to and held by the housing 2, for example. As illustrated in FIG. 1, the accommodating part 6 accommodates the lower display area 30d and holds the image display device 3. The image display device 3 is disposed at an end of the front side X1 in the accommodating part 6, with the display surface 30 facing the rear side X2. The upper display area 30u protrudes upward from the accommodating part 6. The upper display area 30u is accommodated in an internal space 70 of the hood part 7. The hood part 7 has a light-shielding property and covers the upper display area 30u from the front side of the vehicle. The hood part 7 is formed to be able to shield the upper display area 30u from external light. As illustrated in FIG. 1, the hood part 7 has an eave portion 71 that covers the upper display area 30u from above.

As illustrated in FIGS. 1 and 5, the combiner 5 is disposed to cover the internal space 70 of the hood part 7. That is, the combiner 5 is disposed to shield the internal space 70 when viewed from the eye point EP. The illustrated combiner 5 has a substantially hexagonal shape. The upper display area 30u of the image display device 3 is located behind the combiner 5 when viewed from the eye point EP. In other words, the combiner 5 is disposed on the side of eye point EP with respect to the upper display area 30u.

The combiner 5 includes a half-mirror, for example. The combiner 5 is a transparent reflective member that can transmit a part of incident light and reflect a part of incident light. The combiner 5 has a reflective surface 5a facing the eye point EP. The reflective surface 5a may be subjected to a coating process or the like for reflecting light.

As illustrated in FIG. 1, the reflective member 4 is disposed inside the accommodating part 6, and faces the reflective surface 5a of the combiner 5 through the opening 61. The reflective member 4 is disposed at an end of the rear side X2 in the accommodating part 6, and faces the lower display area 30d. The reflective member 4 reflects, toward the combiner 5, display light Lt output from the lower display area 30d. The reflective surface 5a of the combiner 5 reflects the display light Lt of the lower display area 30d toward the eye point EP. A virtual image Vi visually recognized at eye point EP is formed at a position on the front side X1 before the reflecting surface 5a. The virtual image Vi is a virtual image of the lower display area 30d, and includes an image displayed in the lower display area 30d.

As illustrated in FIG. 6, the combiner 5 has a first area 51 and a second area 52. The first area 51 is an area used to display a virtual image. The second area 52 is an area through which a real image is transmitted. The first area 51 is located at an upper part of the combiner 5 and the second area 52 is located at a lower part of the combiner 5. An image of the lower display area 30d of the image display device 3 is projected onto the first area 51. The first area 51 reflects the display light Lt of the lower display area 30d toward the eye point EP. The second area 52 corresponds to an optical path of the display light from the upper display area 30u of the image display device 3 to the eye point EP. The second area 52 transmits a real image of the upper display area 30u toward the eye point EP. The shapes of the illustrated first area 51 and second area 52 are each rectangular.

Note that a lower end of the first area 51 and an upper end of the second area 52 may overlap each other. A length of the first area 51 and a length of the second area 52 in the vehicle width direction Y may be different from each other. The shape of the first area 51 and the shape of the second area 52 are not limited to rectangles. For example, the shapes of the first area 51 and the second area 52 may be determined according to the shape of the combiner 5.

The combiner 5 has end areas 53. The end areas 53 are located on both sides of each of the first area 51 and the second area 52 in the vehicle width direction Y. The vehicle display device 1 of the present embodiment is configured to be able to improve designability by controlling the reflection of structures in the end areas 53, as will be described below.

As illustrated in FIG. 7, the shape of the through hole 80 is similar or analogous to the shape of the combiner 5. The illustrated through hole 80 has a substantially hexagonal shape. Both ends of the through hole 80 in the vehicle width direction Y have an outwardly convex shape and have a bent portion 80v. The through hole 80 has a passage area 80a through which the display light Lt of the lower display area 30d passes. The shape of the passage area 80a is, for example, rectangular or trapezoidal. The display light Lt passing through the passage area 80a of the through hole 80 is projected onto the first area 51 of the combiner 5 and reflected toward the eye point EP. A width of the passage area 80a in the vehicle front-rear direction X is determined, for example, so that the virtual image Vi is seen through even though a height position of the eye point EP changes.

The through hole 80 has a shape with widened portions 80x expanding outward from the passage area 80a. The widened portion 80x is an area outside the passage area 80a in the vehicle width direction Y. That is, the widened portion 80x corresponds to the end area 53 of the combiner 5. The widened portions 80x are provided at both ends of the through hole 80. In the present embodiment, since the through hole 80 has a shape corresponding to the combiner 5, the widened portion 80x has a pentagonal shape.

The inclined portion 81 illustrated in FIG. 7 has a stepped shape. That is, the inclined portion 81 has a plurality of facing surfaces 83 arranged in steps. The facing surface 83 is a surface facing the combiner 5 and is reflected in the combiner 5 when viewed from the eye point EP. The position of the facing surface 83 in the vehicle vertical direction Z is shifted toward the lower side Z2 as it approaches the through hole 80. That is, the inclined portion 81 is formed so that the facing surface 83 moves away from the combiner 5 as it approaches the through hole 80. Each facing surface 83 is bent in correspondence with the bent shape of the through hole 80 and has a bent portion corresponding to the bent portion 80v.

FIG. 8 illustrates the panel member 8 attached to the accommodating part 6. Note that FIG. 8 does not illustrate the hood part 7 and the combiner 5. The panel member 8 is disposed to cover edges of the cover 62. The cover 62 is provided with light-shielding mask parts 64. The color of the mask part 64 is black, for example, and may be a glossy or lustrous color. The color of the mask part 64 may be piano black. The mask part 64 is a light-shielding layer that blocks light, and is formed on the cover 62, for example, by printing. The mask part 64 is provided in an area of the cover 62 facing the widened portion 80x. The mask part 64 is disposed at both ends of the cover 62 in the vehicle width direction Y. The shape of the illustrated mask part 64 is triangular.

The mask part 64 forms a light transmission area 65 on the cover 62. The light transmission area 65 is an area through which light can pass and is located between the two mask parts 64. The display light Lt of the lower display area 30d is projected onto the combiner 5 through the light transmission area 65. The shape of the illustrated light transmission area 65 is trapezoidal. However, the shape of the light transmission area 65 is arbitrary.

The cover 62 of the present embodiment is provided with a gradation area 66 adjacent to the mask part 64. The gradation area 66 is disposed at a boundary between the mask part 64 and the light transmission area 65. The gradation area 66 is formed so that the transmittance of the displayed light gradually increases toward the light transmission area 65 from the mask part 64. The gradation area 66 is formed, for example, by halftone dot printing with a large number of dots as illustrated in FIG. 9. The gradation area 66 can make the boundary between the mask part 64 and the light transmission area 65 less noticeable. The mask part 64 and the gradation area 66 are disposed so as not overlap the passage area 80a of the panel member 8.

As illustrated in FIG. 10, the mask part 64 and the gradation area 66 are disposed on an inner surface 62b of the cover 62. The inner surface 62b is a surface facing the lower side Z2 and faces an internal space of the accommodating part 6. An outer surface 62a of the cover 62 is a surface facing the upper side Z1 and faces the combiner 5. The outer surface 62a is smooth and glossy. The inner surface 62b may be a smooth surface similar to the outer surface 62a.

FIG. 11 illustrates the combiner 5 when an image is displayed. The vehicle display device 1 displays the virtual image Vi and the real image Ri. The virtual image Vi is an image displayed in the lower display area 30d and is reflected by the combiner 5 toward the eye point EP. The real image Ri is an image displayed in the upper display area 30u and is transmitted through the combiner 5 toward the eye point EP. A position where the virtual image Vi is formed when viewed from the eye point EP is a position on the front side X1 with respect to the real image Ri. This can allow a driver to feel a sense of depth.

A virtual image 8v of the instrument panel surface 8a and a virtual image 81v of the inclined portion 81 are reflected in the combiner 5. In the present embodiment, the through hole 80 of the panel member 8 has a hexagonal shape similar to the shape of the combiner 5. The inclined portion 81 has a bent shape corresponding to a bent portion 5b of the combiner 5. Thus, a shape of the virtual image 81v harmonizes with the shape of the combiner 5, so that designability is improved. Furthermore, a sense of discomfort caused by the reflection of the instrument panel surface 8a is reduced.

A virtual image 64v of the mask part 64 is also reflected in the combiner 5. The mask part 64 regulates the leakage of light from the accommodating part 6. Moreover, the mask part 64 is black. Thus, the virtual image 64v becomes a dark black image and is not easily visually recognized from the eye point EP. By darkening the side of an area where the virtual image Vi and the real image Ri are displayed, a sense of depth and a sense of floating are produced. Furthermore, since the inclined portion 81 has a stepped shape, the virtual image 81v further improves a sense of depth.

Note that the panel member 8 may have a shape in which the instrument panel surface 8a is not reflected in the combiner 5 as illustrated in FIG. 12. The through hole 80 illustrated in FIG. 12 is formed to include a region R5 corresponding to the combiner 5. The shape of the widened section 80x illustrated in FIG. 12 is trapezoidal. The widened portion 80x overlaps the region R5 corresponding to the combiner 5. The widened portion 80x is provided to the outside in the vehicle width direction Y beyond the region R5 corresponding to the combiner 5. That is, the range of the widened portion 80x is determined so that the panel member 8 is not reflected in the combiner 5 when viewed from the eye point EP. The range of the widened portion 80x illustrated in FIG. 12 is set so that at least an end 8d of the instrument panel surface 8a in the vehicle width direction Y is not reflected in the combiner 5.

FIG. 13 illustrates a state in which the panel member 8 illustrated in FIG. 12 is attached to the accommodating part 6. Note that FIG. 13 does not illustrate the hood part 7 and the combiner 5. As illustrated in FIG. 13, the mask part 64 of the cover 62 is provided in an area facing the widened portion 80x. The shape of the mask part 64 illustrated in FIG. 13 is a rectangle. The gradation area 66 is provided at the boundary between the mask part 64 and the light transmission area 65.

FIG. 14 illustrates the combiner 5 in which the mask part 64 in FIG. 13 is reflected. The virtual image 64v of the mask part 64 is slightly visible, but is less noticeable than the virtual image 8v (see FIG. 11) of the instrument panel surface 8a. The outer surface 62a of the cover 62 is a smooth surface unlike the instrument panel surface 8a. Thus, when the outer surface 62a is reflected in the combiner 5, a sense of discomfort is less than when the instrument panel surface 8a is reflected in the combiner 5. Even though the smooth outer surface 62a is reflected on the reflective surface 5a of the combiner 5, it is difficult to give a driver a strange feeling.

In the vehicle display device 1 illustrated in FIG. 14, it seems that a large space exists on the sides of the virtual image Vi and the real image Ri. Thus, a sense of floating of the virtual image Vi and the real image Ri is improved. That is, a feeling that the virtual image Vi and the real image Ri are floating in a wide space can be produced. The real image Ri produces a depth by the bird's-eye view. Gradation is applied to an edge of the real image Ri in the vehicle width direction Y so that the edge darkens toward the virtual image 64v. This creates a feeling that a space is expanding outward from the real image Ri.

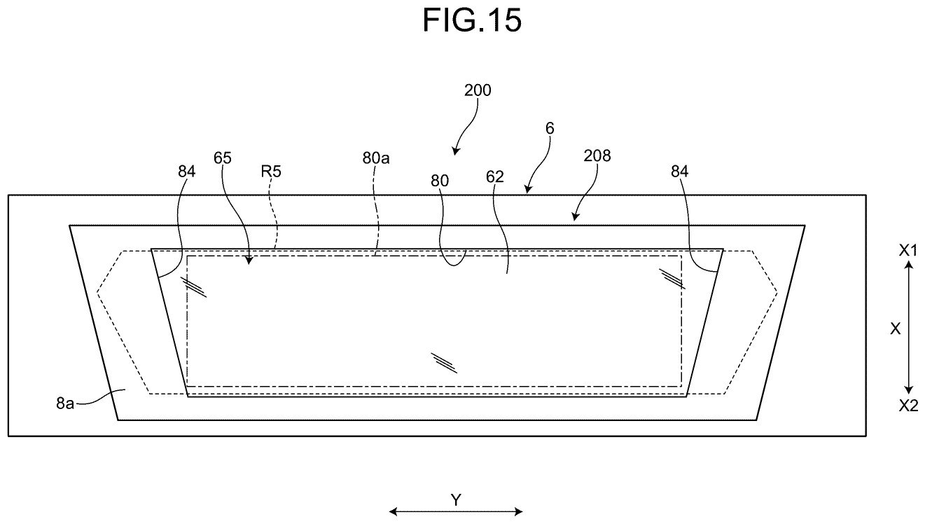

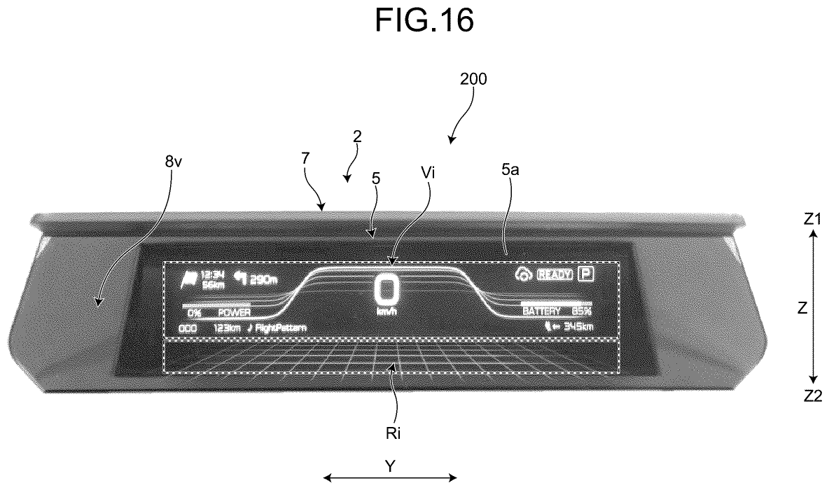

The following is a description of the results of sensory evaluation of the vehicle display device 1 of the present embodiment by a plurality of evaluators. In the following description, the combination of the panel member 8 and the cover 62 illustrated in FIG. 8 is referred to as a “first configuration” and the combination of the panel member 8 and the cover 62 illustrated in FIG. 13 is referred to as a “second configuration”. In the sensory evaluation, a comparison was made with a vehicle display device 200 of a comparative example to be described with reference to FIGS. 15 and 16.

In a panel member 208 of the comparative example illustrated in FIG. 15, the through hole 80 has no widened portion 80x or a widened portion is smaller than that in the embodiment. An end 84 of the through hole 80 is located inside in the vehicle width direction Y from the region R5 corresponding to the combiner 5. The panel member 208 of the comparative example is provided with no inclined portion 81. The cover 62 of the comparative example is also provided with no mask part 64 and no gradation area 66. That is, an entire area of the cover 62 exposed from the through hole 80 is the light transmission area 65.

From the viewpoint of suppressing external light from entering the accommodating part 6, the through hole 80 is preferably made smaller. For example, the through hole 80 is preferably made as small as possible within the range including the passage area 80a. On the other hand, when the through hole 80 is made smaller, an area of the instrument panel surface 8a reflected in the combiner 5 is increased.

As illustrated in FIG. 16, when the panel member 208 of the comparative example is used, the virtual image 8v of the instrument panel surface 8a is reflected in the combiner 5. In the comparative example, the area of the virtual image 8v is larger than in the embodiment. Since the panel member 208 has no inclined portion 81, the edges of the through holes 80 are easily noticeable.

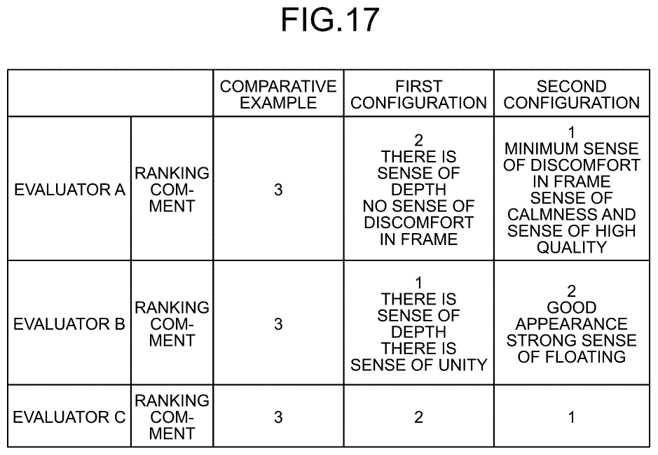

FIG. 17 illustrates the results of an evaluation by three evaluators. This evaluation was conducted in a state in which the vehicle display device 1 of the present embodiment and the vehicle display device 200 of the comparative example are installed in a room and the instrument panel surface 8a is illuminated by room light.

The first configuration was rated as having a sense of unity and no sense of discomfort in a frame, compared to the comparative example. The first configuration was also rated as having a sense of depth, compared to the comparative example. The second configuration was rated as having a sense of calmness and a sense of high quality and having a good appearance, compared to the comparative example. The second configuration was also evaluated as having a good appearance with no sense of discomfort due to the lack of a clear frame. The second configuration was further rated as having a strong sense of floating. Comparing the first configuration with the second configuration, the first configuration received a higher evaluation for a sense of depth, while the second configuration received a higher evaluation for a sense of floating.

As described above, the vehicle display device 1 of the present embodiment has the image display device 3, the hood part 7, the combiner 5, the accommodating part 6, the transparent cover 62, the panel member 8, the reflective member 4, and the mask part 64. The image display device 3 has the upper display area 30u and the lower display area 30d for displaying images, with the upper display area 30u disposed to face the eye point EP of the vehicle 100. The hood part 7 covers the upper display area 30u from the front side of the vehicle. The combiner 5 is disposed on the side of the eye point EP with respect to the upper display area 30u.

The accommodating part 6 accommodates the lower display area 30d and has the opening 61 facing upward. The opening 61 is located on the side of the eye point EP with respect to the image display device 3. The opening 61 is closed by the cover 62. The panel member 8 is disposed on the side of the combiner 5 with respect to the cover 62, and has the through hole 80 facing the cover 62. The reflective member 4 is disposed inside the accommodating part 6 and faces the combiner 5 through the through hole 80. The reflective member 4 reflects the display light Lt of the lower display area 30d toward the combiner 5.

The mask part 64 has a light-shielding property and is disposed on the cover 62. The through hole 80 has a shape with the widened portion 80x that expands outward from the passage area 80a through which the display light Lt traveling toward the eye point EP passes. The mask part 64 is provided in an area of the cover 62 facing the widened portion 80x. Since the panel member 8 of the present embodiment has the widened portion 80x, the area of the instrument panel surface 8a reflected in the combiner 5 can be reduced. Moreover, since the cover 62 is provided with the mask part 64, a portion adjacent to an image when viewed from the eye point EP can be darkened. Thus, the vehicle display device 1 of the present embodiment can improve the designability of image display by the combiner 5.

The range of the widened portion 80x may be determined so that the panel member 8 is not reflected in the combiner 5 when viewed from the eye point EP. The panel member 8 is not reflected in the combiner 5, which can improve designability. The range of the widened portion 80x may also be determined, for example, so that the panel member 8 is not reflected on the side of an image when viewed from the eye point EP.

The widened portion 80x may be provided so that the shape of the through hole 80 reflected in the combiner 5 corresponds to the shape of the combiner 5 when viewed from the eye point EP. For example, the through hole 80 illustrated in FIG. 7 has a hexagonal shape corresponding to the shape of the combiner 5. The shape of the through hole 80 and the shape of the combiner 5 correspond to each other, which improves designability.

The mask part 64 of the present embodiment is disposed on the inner surface 62b of the cover 62. The inner surface 62b is a surface of the cover 62 opposite to a surface of the cover 62 facing the combiner 5. Such a configuration reduces a sense of discomfort with respect to the mask part 64 reflected in the combiner 5.

The accommodating part 6 of the present embodiment is accommodated in the instrument panel 120 of the vehicle 100. The panel member 8 is detachable from the accommodating part 6 without interfering with the instrument panel 120. A user easily exchanges the panel member 8 with his/her favorite panel member 8, thereby improving designability.

Note that the cover 62 may be provided with no gradation area 66. The panel member 8 may not be detachable in a state in which the accommodating part 6 is fixed to the vehicle 100. The upper display area 30u and the lower display area 30d may be separate display devices.

### Variations of Embodiment

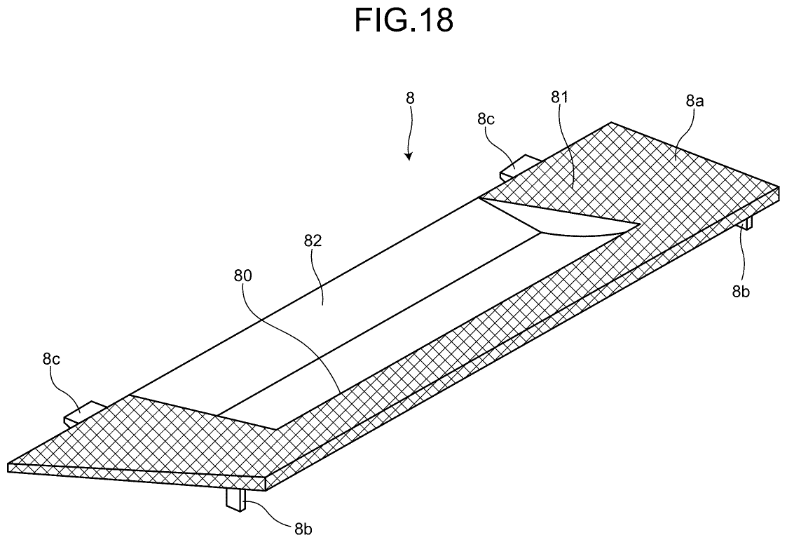

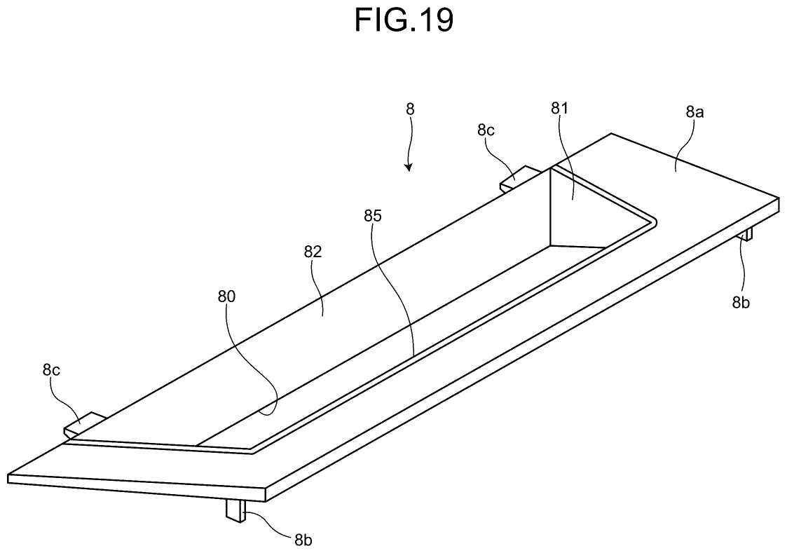

Variations of the embodiment are described. FIGS. 18 and 19 are perspective views of panel members according to variations of the embodiment. The instrument panel surface 8a of the panel member 8 may have a surface finish different from the top surface of an instrument panel 120. In the panel member 8 illustrated in FIG. 18, a carbon-like surface finish is applied to the instrument panel surface 8a.

As illustrated in FIG. 19, the panel member 8 may be provided with a decorative part 85. The decorative part 85 is disposed at an inner boundary on the instrument panel surface 8a. That is, the decorative part 85 divides the panel member 8 into the instrument panel surface 8a and an area inside the instrument panel surface 8a. The decorative part 85 can reduce a sense of discomfort due to the reflection of the instrument panel surface 8a in the combiner 5.

The decorative part 85 may be an independent member or a part of the panel member 8. A surface of the decorative part 85 may be plated. The shape of the decorative part 85 in a plan view preferably corresponds to the shape of the combiner 5. When the combiner 5 is hexagonal, the shape of the decorative part 85 may be a hexagonal outline shape.

The contents disclosed in the above embodiment and variations can be combined and implemented as appropriate.

A vehicle display device according to the present invention includes a transparent cover, a panel member having a through hole facing the cover, and a mask part having a light-shielding property and disposed on the cover. The through hole has a shape with a widened portion expanding outward from an area through which display light traveling toward an eye point passes, and the mask part is provided in an area of the cover facing the widened portion. The vehicle display device according to the present invention can suppress deterioration in designability due to the reflection of an opening in a combiner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
an image display device including an upper display area and a lower display area for displaying an image and disposed so that the upper display area faces an eye point of a vehicle;
a hood part that covers the upper display area from a front side of the vehicle;
a combiner disposed on a side of the eye point with respect to the upper display area;
an accommodating part that accommodates the lower display area and has an opening facing upward, the opening being located on a side of the eye point with respect to the image display device;
a transparent cover that closes the opening;
a panel member disposed on a side of the combiner with respect to the cover and having a through hole facing the cover;
a reflective member disposed inside the accommodating part, facing the combiner through the through hole, and reflecting display light of the lower display area toward the combiner; and
a mask part having a light-shielding property and disposed on the cover, wherein
the through hole has a shape with a widened portion expanding outward from an area through which the display light traveling toward the eye point passes, and
the mask part is provided in an area of the cover facing the widened portion.

2. The vehicle display device according to claim 1, wherein a range of the widened portion is determined so that the panel member is not reflected in the combiner when viewed from the eye point.

3. The vehicle display device according to claim 1, wherein the widened portion is provided so that the shape of the through hole reflected in the combiner corresponds to a shape of the combiner when viewed from the eye point.

4. The vehicle display device according to claim 1, wherein the mask part is disposed on a surface of the cover opposite to a surface of the cover facing the combiner.

5. The vehicle display device according to claim 2, wherein the mask part is disposed on a surface of the cover opposite to a surface of the cover facing the combiner.

6. The vehicle display device according to claim 3, wherein the mask part is disposed on a surface of the cover opposite to a surface of the cover facing the combiner.

7. The vehicle display device according to claim 1, wherein
the accommodating part is accommodated in an instrument panel of the vehicle, and
the panel member is detachable from the accommodating part without interfering with the instrument panel.

8. The vehicle display device according to claim 2, wherein
the accommodating part is accommodated in an instrument panel of the vehicle, and
the panel member is detachable from the accommodating part without interfering with the instrument panel.

9. The vehicle display device according to claim 3, wherein
the accommodating part is accommodated in an instrument panel of the vehicle, and
the panel member is detachable from the accommodating part without interfering with the instrument panel.
